(19) United States
(12) Patent Application Publication
(10) Pub. No.: US 2016/0335168 A1
(43) Pub. Date: Nov. 17, 2016

(54) REAL-TIME ANALYSIS OF APPLICATION PROGRAMMING INTERFACES

(71) Applicant: Microsoft Technology Licensing, LLC, Redmond, WA (US)

(72) Inventors: Oren Freiberg, Seattle, WA (US); Choo Yei Chong, Redmond, WA (US)

(73) Assignee: Microsoft Technology Licensing, LLC, Redmond, WA (US)

(21) Appl. No.: 14/714,014

(22) Filed: May 15, 2015

(51) Int. Cl. G06F 11/36

(52) U.S. Cl. CPC G06F 11/3604

(57) ABSTRACT

Systems and methods disclosed herein may include real-time analysis of application programming interfaces (APIs). The method may include detecting that the programming code input is associated with at least a portion of an application programming interface (API). At least one coding error associated with the API may be detected based on static analysis of the code. The static analysis may include receiving an indication of a browser version, and comparing the received code with programming code for the API verified for the browser version, to detect the at least one coding error. Information identifying at least a first remediation action for correcting the at least one coding error may be received based at least in part on the at least one browser version. The at least a first remediation action may be provided for display to a user of the computing device.

### BACKGROUND

Modern integrated development environments (IDEs) provide a number of tools to facilitate the tasks of writing code, detecting problems in the grammar or syntax of the code, and fixing problems. When web developers write code, they typically target web pages or applications associated with a specific web browser (or browsers).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a computing device may include a processing unit, memory, and a display. The computing device may be configured to perform operations for real-time analysis of application programming interfaces (APIs). The operations may include receiving a selection of at least one browser version from a plurality of browser versions available in an integrated development environment (IDE). Programming code input is received. The operations may further include detecting that at least a portion of the programming code input is associated with an application programming interface (API). Compatibility of the API with the at least one browser version may be determined. An indication of the determined compatibility of the API may be provided (e.g., the indication may be provided while receiving and/or displaying the programming code input).

In accordance with one or more aspects, a method for real-time analysis of application programming interfaces (APIs) may include, in response to at least receiving programming code input, detecting the programming code input is associated with at least a portion of an application programming interface (API). At least one coding error associated with the API may be detected based on static analysis of the received programming code input. The static analysis may include receiving an indication of at least one browser version for a browser associated with implementing the programming code. The static analysis may further include comparing the received programming code with programming code for the API verified for the at least one browser version, to detect the at least one coding error. Information identifying at least a first remediation action for correcting the at least one coding error may be received based at least in part on the at least one browser version. The at least a first remediation action may be provided (e.g., in real-time) for display to a user of the computing device.

In accordance with one or more aspects, a computer-readable storage medium having instructions thereon for performing a method for real-time analysis of application programming interfaces (APIs) is provided. The method may include receiving a selection of a browser version for a browser used in an integrated development environment (IDE). At least a portion of programming code input can be detected that it is associated with an application programming interface (API). Static analysis of the programming code input may be performed using a static analysis engine at the computing device, to detect at least one coding error associated with the API. Compatibility data indicating whether the programming code input associated with the API is compatible with the browser version, may be received from a compatibility analysis engine. While displaying at least a portion of the programming code input, a first indication of the at least one coding error and a second indication of the compatibility data may be provided for display.

As described herein, a variety of other features and advantages can be incorporated into the technologies as desired.

### BRIEF DESCRIPTION OF THE DRAWINGS

FIG. 1 illustrates an example system in which real-time analysis of application programming interfaces (APIs) discussed herein can be used.

FIG. 2 is a block diagram illustrating an example compatibility analysis engine, in accordance with one or more embodiments.

FIG. 3 is a block diagram of a solutions database used in connection with compatibility analysis, in accordance with one or more embodiments.

FIG. 4 is a flow diagram illustrating example detection of an API, in accordance with one or more embodiments.

FIG. 5 is a flow diagram illustrating example static analysis and compatibility analysis for an entered API, in accordance with one or more embodiments.

FIG. 6 is a flow diagram illustrating example compatibility analysis for an API, in accordance with one or more embodiments.

FIGS. 7-8 are flow diagrams illustrating example real-time analysis of application programming interfaces (APIs), in accordance with one or more embodiments.

FIG. 9 is a diagram of an example computing system, in which some described embodiments can be implemented.

FIG. 10 illustrates a generalized example of a suitable cloud-supported environment, in which described embodiments, techniques, and technologies may be implemented.

FIG. 11 is an example mobile device that can be used in conjunction with the technologies described herein.

### DETAILED DESCRIPTION

A common problem for web developers in an IDE is that it is often times difficult to know in advance which application programming interfaces (APIs) are supported by which browsers (API compatibility information is generally not available to the web developer while writing code, unless a limited set of APIs is used). Using an incompatible and untested API may result in the finished product (e.g., web page or application) working with one browser but have issues with another browser. To solve this problem, a web developer will typically search the web for reference web sites and other reference materials describing which browsers support a given API. This task will result in substantial delays and interruption of the programming workflow of the developer. The web developer may also complete the product using a given API and then test the finished product against different browsers. However, this processing flow will also result in additional delay and inefficiencies as the developer has to perform additional testing/verification and resolve any issues (e.g., programming errors or “bugs”) discovered during the testing. Additionally, some programming languages, such as HTML, JavaScript and CSS, are being continuously updated and there may be no easy verification step or a single set of APIs to build against when using these languages. Therefore, the need exists for a solution that provides efficient ways to verify and conform APIs in an integrated development environment.

As described herein, various techniques and solutions can be applied to perform real-time analysis of application programming interfaces (APIs). More specifically, static analysis of a detected API may be performed to determine whether the API (as entered) has any coding errors, and whether or not it can be used as entered. The static analysis may be implemented as a code analyzer engine that utilizes data from the cloud (e.g., one or more databases of available APIs for one or more programming languages and/or browsers, coding errors database, etc.) As the developer enters programming code, the API static analysis may be performed in real-time, and any detected coding error may be highlighted (as well as one or more suggested solutions to the coding errors may be provided). In addition to the static analysis, a compatibility analysis may be performed based on a compatibility of the detected API with a browser version. For example, a browser version may be selected by the developer (or it may be indicated in a developer profile or as part of the programming code that is entered). The detected/entered API may be analyzed to determine whether the API (or one or more portions of the API) are compatible with the selected browser version (or versions). The compatibility analysis may be performed in real-time (e.g., concurrently with, or subsequent to, the static analysis), and results of the compatibility analysis may be provided to the developer while the code is being entered (e.g., real-time highlighting or another type of output of what portion of the API is compatible with, and what portion is not compatible with, the indicated browser version). The compatibility analysis may be performed by a dedicated engine or by the static analysis engine, using one or more of the cloud resources used for static analysis and/or other resources used to determine API compatibility.

The resources used for the compatibility and static analyses (e.g., the available APIs database, database of API coding errors, a solutions database and so forth) may be implemented locally (e.g., at the client device) and/or in the cloud (e.g., at a server computer communicatively coupled to the client computing device). Additionally, such resources can be kept updated periodically so that the most up-to-date versions of the available APIs and other data resources are being utilized for the static and compatibility analyses. In this regard, web developers may improve upon using a static core API (e.g., a limited set of APIs available to the programmer where verification and coding error check may be performed at the time of programming but only against the limited, and not up-to-date, static core API data). More specifically, using the techniques described herein, a web developer may use a dynamic core API (e.g., an API which may be continuously changing/updating between different browsers and between different browser versions of the same browser)

The above static/compatibility analysis functions may be part of a real-time API analysis (RTAA) engine (or service), which may be implemented as a stand-alone application (or app), as part of an existing web development application, and/or as part of a device operating system (“OS”).

As used herein, the term “application programming interface” (or API) refers to a set of programming instructions for accessing a web-based software application, a web tool or a service. In this regard, an API is source code interface that a computer system or a program library provides in order to support requests for services from a software application. An API can be specified in terms of a programming language that can be compiled at application build time.

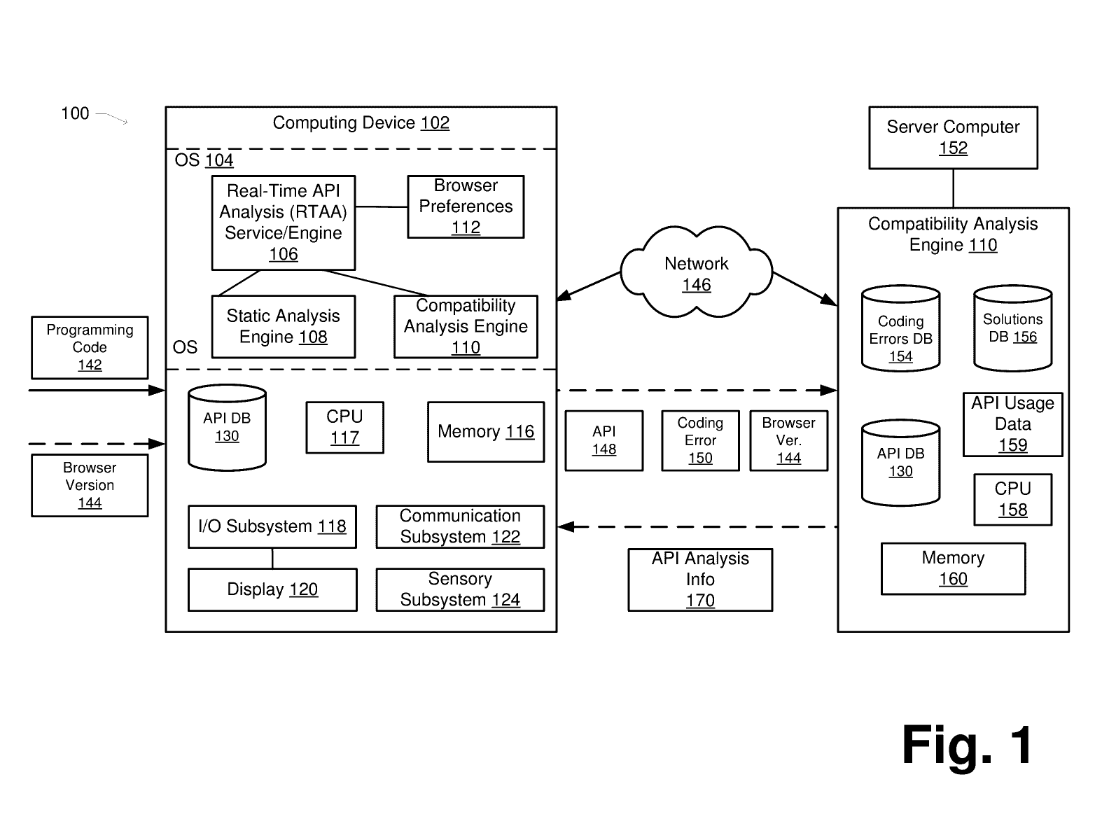

FIG. 1 illustrates an example system in which real-time analysis of application programming interfaces (APIs) discussed herein can be used. The system 100 includes a computing device 102, which can be any of a variety of types of devices, although typically is a mobile device. For example, the computing device 102 can be a smart phone or other wireless phone, a laptop or netbook computer, a tablet or notepad computer, a wearable computer, a mobile station, an entertainment appliance, an audio and/or video playback device, a game console, an automotive computer, and so forth. The computing device 102 is typically referred to as being a mobile device because the device 102 is designed or intended to be moved to multiple different locations (e.g., taken by a user with him or her as the user goes to different locations).

The device 102 may further comprise a main processor (or CPU) 117, memory 116, input/output (I/O) subsystem 118, a communication subsystem 122, a display 120, and a sensory subsystem 124. The device 102 may be running an operating system (OS) 104, and may also implement one or more data stores, such as an API database 130, and a real-time API analysis (RTAA) module 106.

The main processor 117 may comprise suitable logic, circuitry, interfaces, and/or code that may be operable to process data, and/or control and/or manage operations of the computing device 102, and/or tasks and/or applications performed therein in connection with real-time API analysis functions described herein. In this regard, the main processor 117 may be operable to configure and/or control operations of various components and/or subsystems of the computing device 102 by utilizing, for example, one or more control signals. The main processor 117 enables running and/or execution of applications, programs and/or code, which may be stored, for example, in the system memory 116. In some instances, one or more of the applications running and/or executing on the computing device 102 (e.g., the RTAA engine 106) may generate and/or update video content that may be rendered via the display 120.

The system memory 116 may comprise suitable logic, circuitry, interfaces, and/or code that may enable permanent and/or non-permanent storage, buffering, and/or fetching of data, code and/or other information, which may be used, consumed, and/or processed. In this regard, the system memory 116 may comprise different memory technologies, including, for example, read-only memory (ROM), random access memory (RAM), Flash memory, solid-state drive (SSD), and/or field-programmable gate array (FPGA). The system memory 116 may store, for example, configuration data, which may comprise parameters and/or code, comprising software and/or firmware.

The communication subsystem 122 may comprise suitable logic, circuitry, interfaces, and/or code operable to communicate data from and/or to the computing device 102, such as via one or more wired and/or wireless connections and the network 146. The communication subsystem 122 may be configured to support one or more wired protocols (e.g., Ethernet standards, MOCA, etc.) and/or wireless protocols or interfaces (e.g., CDMA, WCDMA, TDMA, GSM, GPRS, UMTS, EDGE, EGPRS, OFDM, TD-SCDMA, HSDPA, LTE, WiMAX, WiFi, Bluetooth, and/or any other available wireless protocol/interface), facilitating transmission and/or reception of signals to and/or from the computing device 102, and/or processing of transmitted or received signals in accordance with applicable wired or wireless protocols. In this regard, signal processing operations may comprise filtering, amplification, analog-to-digital conversion and/or digital-to-analog conversion, up-conversion/down-conversion of baseband signals, encoding/decoding, encryption/decryption, and/or modulation/demodulation. In accordance with an embodiment of the disclosure, the communication subsystem 122 may provide wired and/or wireless connections to, for example, the server computer 152 (e.g., a cloud server computer) implementing the compatibility analysis engine 110, via the network 146. The network 146 may include the Internet and/or one or more wired and/or wireless networks.

The sensory subsystem 124 may comprise suitable logic, circuitry, interfaces, and/or code for obtaining and/or generating sensory information, which may relate to the computing device 102, its user(s), and/or its environment. For example, the sensory subsystems 124 may comprise positional or locational sensors (e.g., GPS or other GNSS based sensors), ambient conditions (e.g., temperature, humidity, or light) sensors, and/or motion related sensors (e.g., accelerometer, gyroscope, pedometers, and/or altimeters).

The I/O subsystem 118 may comprise suitable logic, circuitry, interfaces, and/or code for enabling user interactions with the device 102, enabling obtaining input from user(s) and/or to providing output to the user(s). The I/O subsystem 118 may support various types of inputs and/or outputs, including, for example, video, audio, and/or textual. In this regard, dedicated I/O devices and/or components, external to or integrated within the computing device 102, may be utilized for inputting and/or outputting data during operations of the I/O subsystem 118. Exemplary I/O devices may comprise one or more built-in cameras (e.g., front-facing and/or rear-facing camera), one or more displays (e.g., display 120), mice, keyboards, touchscreens, voice input interfaces, and other input/output interfaces or devices. With respect to video outputs, the I/O subsystem 118 may be operable to generate and/or process video content, graphics, and/or textual data, and/or generate video frames based thereon for display, via the display 120 for example.

The display 120 may comprise suitable logic, circuitry, interfaces and/or code that may enable displaying of video content, which may be handled and/or processed via the I/O subsystem 118. The display 120 may be used in outputting data during real-time API analysis by the RTAA engine 106.

The RTAA module 106 may comprise suitable circuitry, interfaces, logic and/or code and may be implemented as a service (or an engine) running as part of the OS 104, as part of another application running on the device 102, and/or as a stand-alone application (separately from the OS 104). The RTAA engine 106 may further use browser preferences 112, a static analysis engine 108, and a compatibility analysis engine 110. Even though the RTAA engine 106 is illustrated separate from the static analysis engine 108 and the compatibility analysis engine 110, the disclosure is not limited in this regard and the engines 108-110 may be implemented as part of the RTAA engine 106.

The static analysis engine (SAE) 108 may comprise suitable circuitry, interfaces, logic and/or code and may be operable to perform static analysis for an API (e.g., a complete API that has been entered via the device 102 or at least a portion of a known API). The SAE 108 may determine whether an API has been entered (or whether a portion of a known API has been entered at the device 102), and whether any coding errors are present in the API as entered. In this regard, the SAE 108 may use one or more databases to perform the API recognition and coding error detection functionalities. For example, the SAE 108 may use the API database 130 to detect an API that is being entered by a user of device 102 (e.g., via the entered programming code 142), and/or one or more of the databases 154-156 used by the compatibility analysis engine 110.

The compatibility analysis engine (CAE) 110 may comprise suitable circuitry, interfaces, logic and/or code and may be operable to perform compatibility analysis for one or more APIs in real-time. More specifically, the CAE 110 may detect whether an API that is being entered by a user (or an API that has been entered) of device 102 is compatible with one or more selected browsers (or browser versions) (e.g., as indicated by the browser preferences 112). The compatibility determination by the CAE 110 (as well as the static analysis by the SAE 108) may be performed in real-time, e.g., while a user of device 102 is entering programming code 142 for an API.

In accordance with an example embodiment, the CAE 110 (and/or the SAE 108) may be implemented in a cloud computing environment, e.g., on a server computer 152 that is communicatively coupled to device 102 via the network 146. As illustrated in FIG. 1, the CAE 110 may be implemented as a stand-alone device (e.g., peripheral of the server 152) using a separate CPU 158 and memory 160, or the CAE 110 may be implemented within the server 152 (e.g., running as a separate application and/or as part of the server OS). The CAE 110 may further comprise the API database 130, a coding errors database 154, a solutions database 156, and API usage data 159. The coding errors database 154 may include information on various coding errors for a given API, based on programming language and/or browser version. The solutions database 156 may include information on one or more solutions (or remediation actions), which may be performed in order to fix/remediate a given coding error and/or browser incompatibility issue detected by the SAE 108 and/or the CAE 110. The API usage data 159 may provide statistical data regarding use of a given API used with a specified programming language and for a specified browser version.

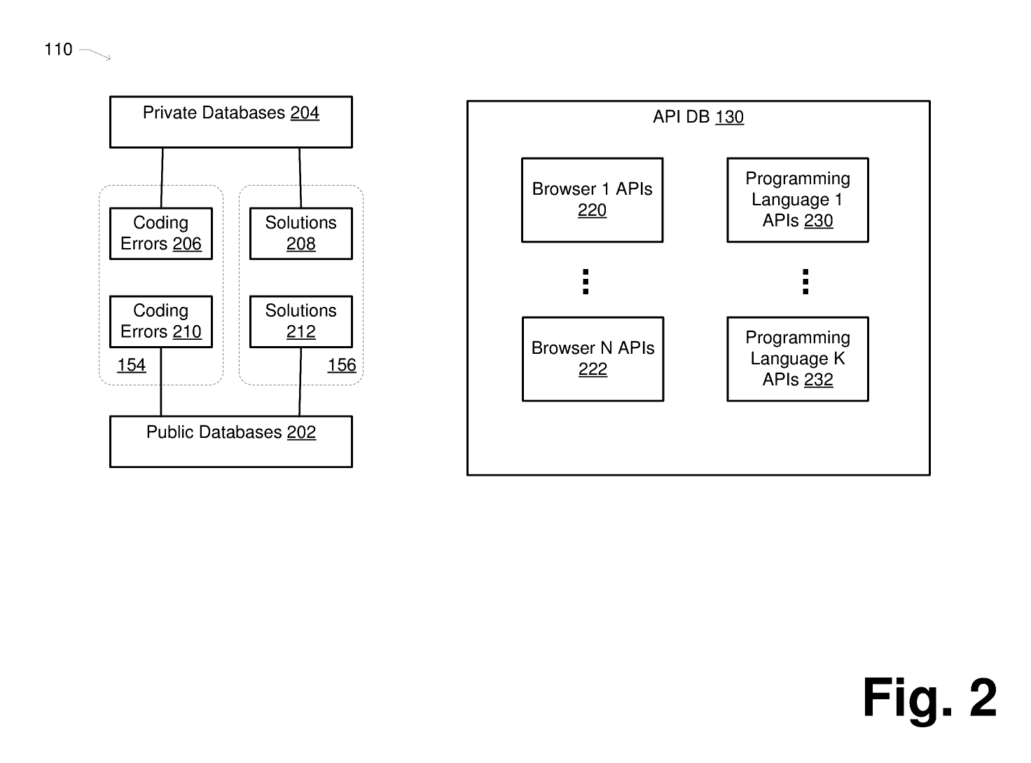

FIG. 2 is a block diagram illustrating an example compatibility analysis engine, in accordance with one or more embodiments. Referring to FIG. 2, there is illustrated a more detailed diagram of the compatibility analysis engine 110. More specifically, the coding errors database 154 and the solutions database 156 may each include a private database component (e.g., 206, 208) and a public database component (210, 212). Alternatively, the private database components 206 and 208 may form a private database 204, and the public database components 210 and 212 may form a public database 204 (each of the databases 204 and 202 including coding errors and solutions data). The private databases 204 may be private to the cloud environment of the server computer 152, and only devices that are connected to the cloud environment (or a customers of one or more services offered by the cloud environment) may access the private databases 204. The public databases 202 may include data that is publicly available (e.g., on one or more web sites) and is aggregated into the public databases 202. Both the public and private databases may be periodically updated by, e.g., the server computer 152 (e.g., automatically and at a pre-determined interval).

The API database 130 within the compatibility analysis engine 110 may further comprise data identifying APIs organized based on, e.g., browser version, programming language or other criteria. For example, the API database 130 may include information 220, . . . , 222 identifying available APIs for browsers (or browser versions) 1, N, respectively. Similarly, the API database 130 may include information 230, . . . , 232 identifying available APIs for programming languages 1, K, respectively.

In accordance with an example embodiment, one or more of the databases within the compatibility analysis engine 110 (or the entire engine 110) may be implemented within the computing device 102.

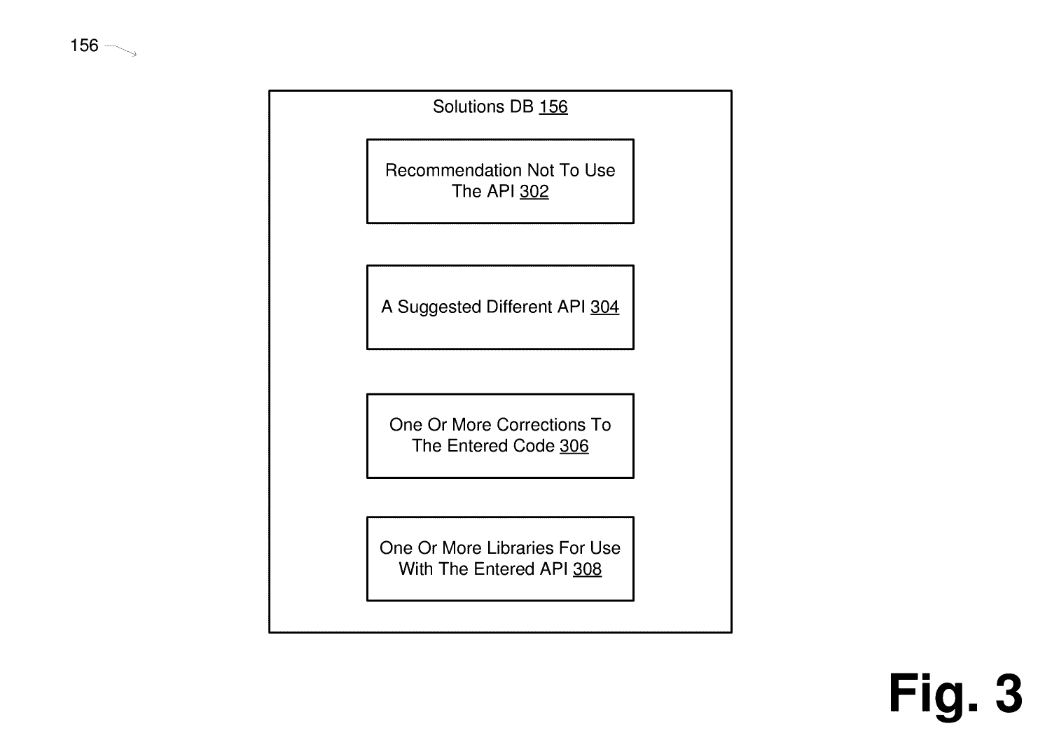

FIG. 3 is a block diagram of a solutions database used in connection with compatibility analysis, in accordance with one or more embodiments. Referring to FIG. 3, there is illustrated a more detailed view of the solutions database 156 within the compatibility analysis engine 110. More specifically, the solutions database 156 may include a plurality of different types of solutions, which may be offered by the RTAA engine 106 and provided for display to the user/programmer entering the programming code 142. Some example solutions may include a recommendation 302 for not using the corresponding API that is being analyzed by the RTAA engine 106; a suggested alternative API 304 (e.g., an API with similar functionality as the currently analyzed API but with better compatibility results with the desired/selected browser version); one or more corrections 306 to the current API (e.g., corrections to remedy one or more identified coding errors or compatibility issues); and one or more libraries 308 for use with the current API (e.g., there may be available libraries which can be used together with the API to achieve desired functionalities while ensuring compatibility with the selected browser version). Even though only four solutions are illustrated in FIG. 3, the present disclosure is not limited in this regard and other solutions may be used as well.

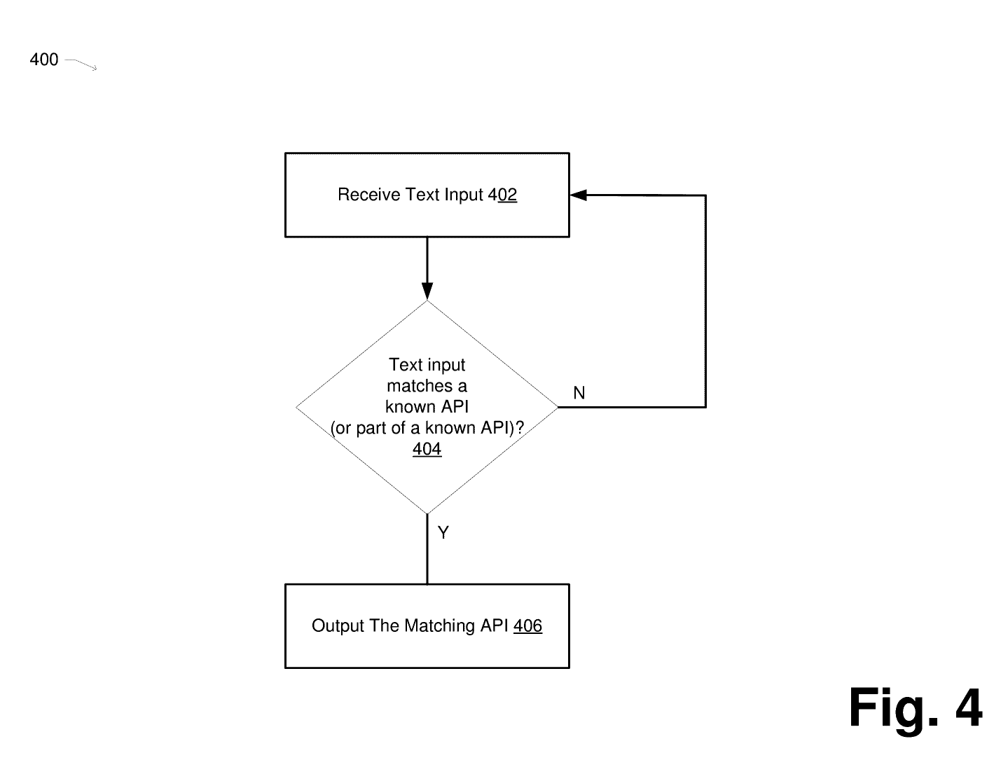

FIG. 4 is a flow diagram illustrating example detection of an API, in accordance with one or more embodiments. Referring to FIGS. 1-4, the example method 400 may start at 402, when text input may be received. For example, a user (e.g., web developer) may enter programming code 142 using device 102. At 404, the RTAA engine 106 may determine (e.g., in real-time, as the programming code 142 is received) whether the text input (or programming code 142) matches a known API (or a part of a known API). The API detection functionality may be performed by the static analysis engine 108 and/or the compatibility analysis engine 110, using the API database 130. At 406, the detected API may be output (e.g., displayed on the device screen 120) or otherwise stored for further processing (e.g., stored in memory 116 and further analysis may be performed, such as compatibility analysis).

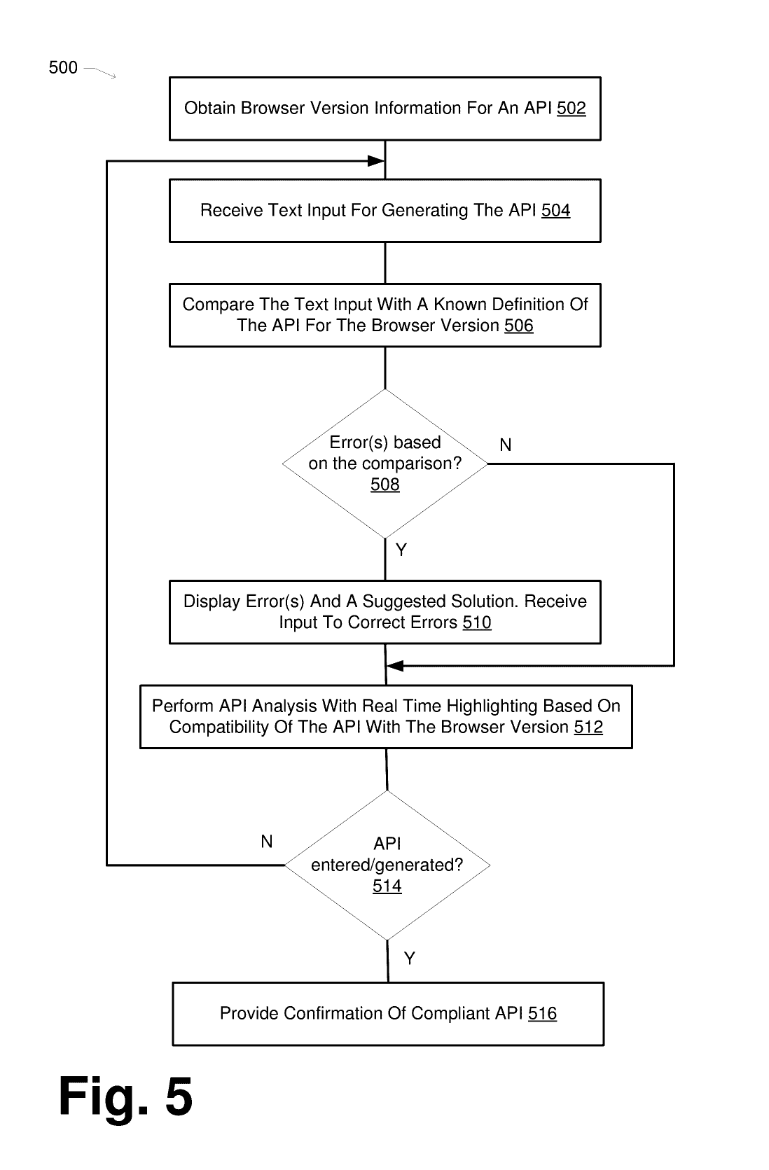

FIG. 5 is a flow diagram illustrating example static analysis and compatibility analysis for an entered API, in accordance with one or more embodiments. Referring to FIG. 5, the example method 500 may start at 502, when a browser version information is obtained. For example, a user may have specified a browser preference 112 (e.g., of a specific browser or browser version), or a browser preference (e.g., browser version 144) may be indicated with the programming code 142.

At 504, text input for generating the API may be received at 504. For example, the programming code 142 may be entered via the device 102. At 506, the text input may be compared with a known definition of an API for the selected browser version. For example, the RTAA engine 106 (or the static analysis engine 108) may compare the entered programming code 142 with APIs within the API database 130 (e.g., one or more of the APIs 220, . . . , 222 associated with the selected browser version or versions).

At 508, it may be determined whether the programming code 142 has any errors based on the comparison with the known definition of the API for the selected browser version. If there are no detected errors, processing may continue at 512. If errors are detected, at 510, the static analysis engine 108 may display the errors (e.g., highlight the incorrect portion of the entered programming code 142) as well as a suggested solution (e.g., from the solutions databases 208, 212). Additional programming input may then be received to correct the indicated errors (e.g., using the suggested solution).

In reference to FIG. 1, the static analysis engine 108 may analyze the programming code 142 and determine that an API 148 is being entered at the device 102. Additionally, the static analysis engine 108 may determine that a coding error 150 is present within the entered code 142.

For example, the entered code 142 may include the following API:

<input type=“date” name=“bday”>.

The static analysis engine 108 may determine that entered API has a coding error (e.g., the incorrect tags of “date” and “bday” may be highlighted), and the correct API (e.g., suggested solution) is the following API compatible with IE11:

<input type=“text” name=“lastname”>.

As another example of coding errors, the entered code 142 may include the following API:

Website.prototype.display = function ( ) {
this.clearPage( );

this.func = setFunc(function( ) {

this.resetPage( );
}, 0);
};

The static analysis engine 108 may detect a coding error 150, and may indicate the following replacement API as a suggested solution:

```
Website.prototype.display = function ( ) {
Var self = this;
  self.clearPage( );
  self.func = setFunc(function( ) {
```

self.resetPage( );

}, 0);
};

As another example of coding errors, the entered code 142 may include the following part of an API:

“X=10”.

However, the static analysis engine 108 may determine that “X” has not been defined, the above entered code may be highlighted, and the following solution may be provided as a suggested correction:

“Var X=10”.

As another example of coding errors, the entered code 142 may include the following part of an API:

return
{
‘name’ : ‘Oren,
}

However, the static analysis engine 108 may determine that the above API pattern is incorrect, and the following solution may be provided as a suggested correction:

Return {
‘name’ : ‘Oren,
}

In reference to FIG. 5, the compatibility processing may be performed starting at 512. More specifically, the RTAA engine 106 (and/or the static analysis engine 108) may communicate the detected API 148, the browser version 144, and/or the coding error 150 to the compatibility analysis engine 110. The CAE 110 may perform API compatibility analysis in real-time (with real-time highlighting of incompatible portions of the API), based on compatibility of the API (or the entered API code) with the selected browser version 144. After the compatibility analysis is complete, API analysis information 170 may be sent back to the device 102. The API analysis information may include one or more detected incompatible portions of the API and/or one or more suggested solutions (e.g., correction in the API or a replacement API).

In an example embodiment, the API analysis information 170 may include API usage data 159 for the API 148. In this regard, the API analysis information may provide one or more solutions to detected coding errors and/or incompatibility, and the usage data 159 may indicate how popular (e.g., how many users or percent of users have implemented) the suggested solution (or solutions).

At 514, it may be determined whether the entire API has been entered, and if it has not, real-time analysis (e.g., static and compatibility) analysis may continue as the user/programmer is entering additional code 142. If the API has been entered, then a final confirmation of a compliant API may be provided at 516 (or an indication of one or more detected incompatible portions in the entered API).

As another example of compatibility analysis and remediation of a detected incompatibility, the entered code 142 may include the following API for showing the width and height of a browser window:

Width=window.innerWidth;

Height=window.innerHeight.

The browser version 144 may indicate version 11 of Internet Explorer (IE11). The CAE 110 may determine that the entered API is unsupported by IE11, a coding error 150 can be indicated (e.g., the entered API may be highlighted), and the following suggested solution may be provided as a valid IE11 API:

Width=document.documentElement.clientWidth;

Height=document.documentElement.clientHeight.

In an example embodiment, the API analysis information 170 may include static analysis and/or compatibility analysis

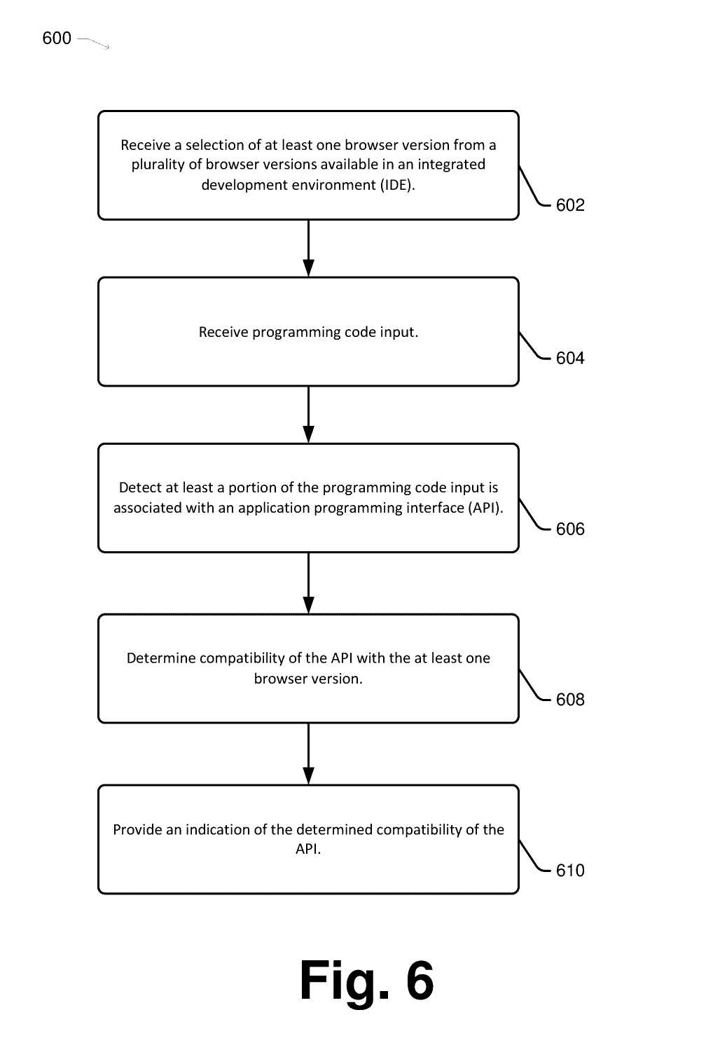

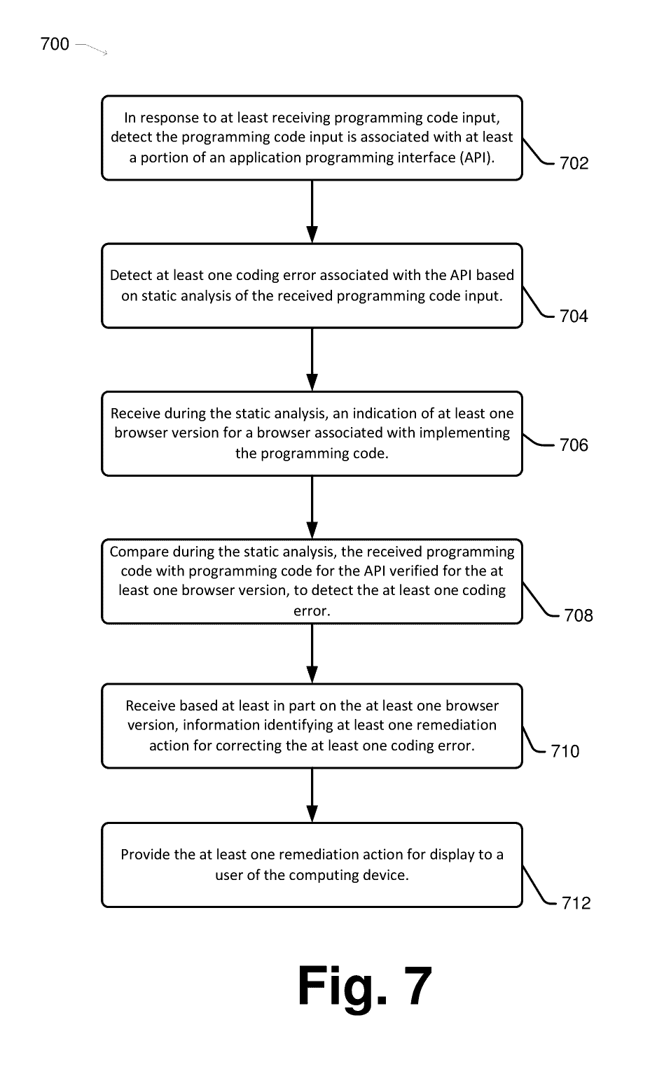

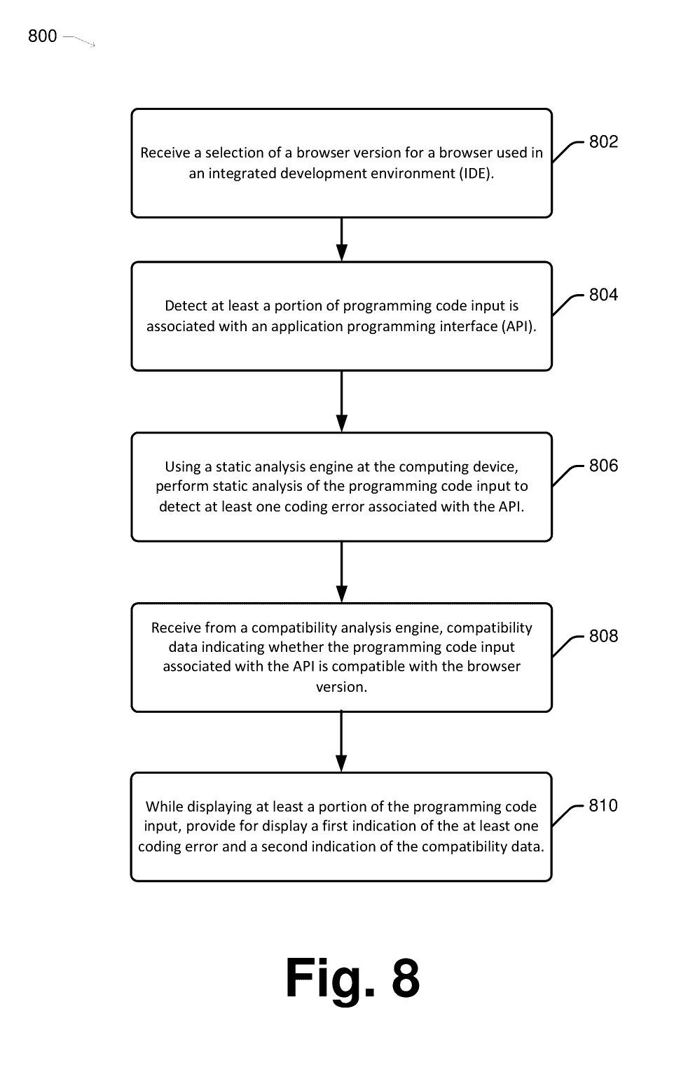

FIGS. 6-8 are flow diagrams illustrating example real-time analysis of application programming interfaces (APIs), in accordance with one or more embodiments. Referring to FIGS. 1-3 and 6, the example method 600 may start at 602, when a selection of at least one browser version from a plurality of browser versions available in an integrated development environment (IDE) is received. For example, the computing device 102 receives the browser version input 144. At 604, the computing device 102 may receive the programming code input 142. At 606, the RTAA engine 106 (which may include the engines 108, 110) may detect at least a portion of the programming code input 144 is associated with an application programming interface (API) (e.g., API 148). The API 148 may include the API as entered with the programming code 142 without any static analysis corrections, or after static analysis (and any suggested corrections) have been performed. At 608, the compatibility engine 110 may determine compatibility of the API (e.g., the entered API 148) with the at least one browser version (e.g., 144). At 610, an indication of the determined compatibility of the API (e.g., as received with the API analysis information 170) may be provided. For example, such indication may be provided while receiving the programming code input 144 (or at a time that is substantially close to a time that the programming code has been received).

Referring to FIGS. 1-3 and 7, the example method 700 may start at 702, when the RTAA engine 106 (including the engines 108, 110) in response to at least receiving programming code input, may detect that entered programming code input (e.g., 142) is associated with at least a portion of an application programming interface (API) (e.g., 148). At 704, the RTAA engine 106 (or the SAE 108) may also detect at least one coding error (e.g., 150) associated with the API based on static analysis of the received programming code input 142. In some instances, the detection of the programming code input and the coding error may be performed in real-time, while the programming code 142 is being received. The static analysis (e.g., as performed by the SAE 108) may include receiving (at 706) an indication (e.g., 144 or an indication from the preferences 112) of at least one browser version for a browser associated with implementing the programming code. At 708, the SAE 108 and/or the CAE 110 may compare the received programming code 142 with programming code for the API verified for the at least one browser version, to detect the at least one coding error (e.g., 150). At 710, the RTAA engine 106 may receive information (e.g., 170) identifying at least a first remediation action (e.g., selected from the solutions database 156) for correcting the at least one coding error, the remediation action selection based at least in part on the at least one browser version. At 712, the at least a first remediation action may be provided (e.g., in real-time) for display to a user of the computing device.

Referring to FIGS. 1-3 and 8, the example method 800 may start at 802, when the RTAA engine 106 may receive a selection of a browser version (e.g., 144 or based on the preferences 112) for a browser used in an integrated development environment (IDE). At 804, the RTAA engine 106 may detect at least a portion of the programming code input 142 is associated with an application programming interface (API) (e.g., API 148). At 806, the RTAA engine 106 may use a static analysis engine (e.g., 108), to perform static analysis of the programming code input 142 to detect at least one coding error (e.g., 150) associated with the API. At 808, the RTAA engine 106 may receive (e.g., from a compatibility analysis engine 110), compatibility data (e.g., API analysis information 170) indicating whether the programming code input 142 associated with the API is compatible with the selected browser version (e.g., 144). At 810, a first indication of the at least one coding error (e.g., 150) and a second indication of the compatibility data (e.g., 170) may be provided (e.g., for display) at the device 102, while displaying at least a portion of the programming code input 142. In some instances, the first indication of the at least one coding error (e.g., 150) and a second indication of the compatibility data (e.g., 170) may be provided (e.g., for display) at the device 102, while the programming code input 142 is being received (or within a time period after the code input has been received).

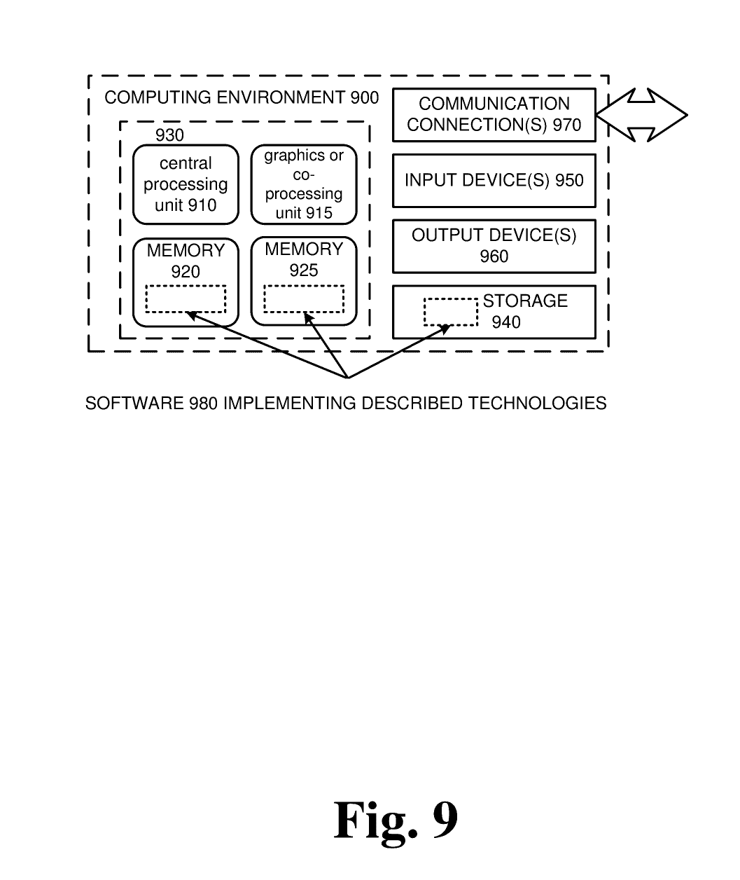

FIG. 9 is a diagram of an example computing system, in which some described embodiments can be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may also have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

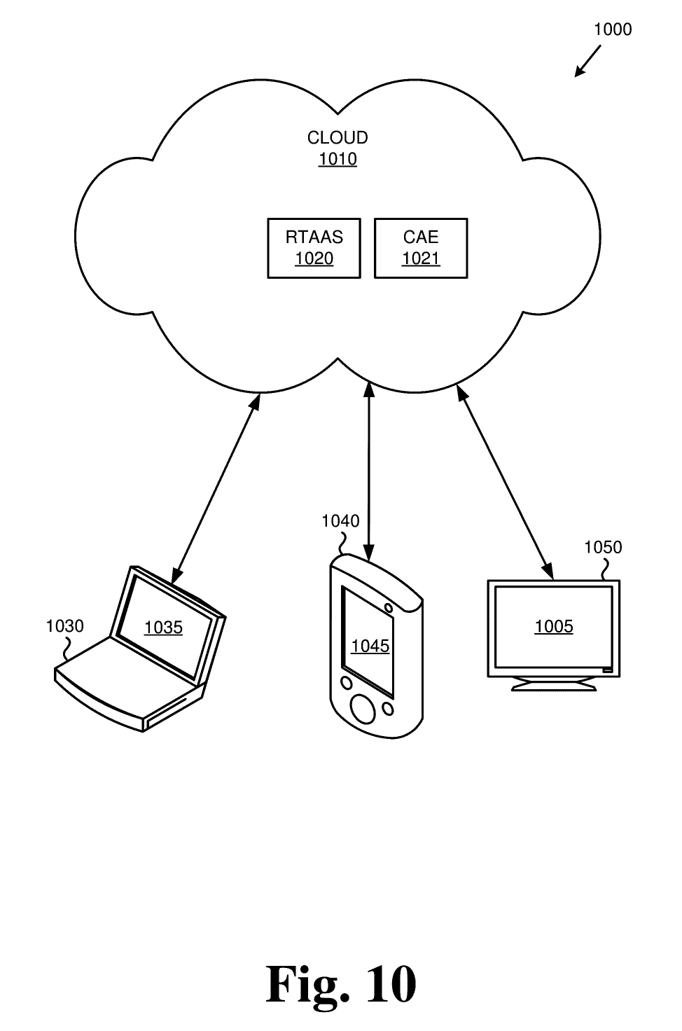

FIG. 10 illustrates a generalized example of a suitable cloud-supported environment 1000, in which described embodiments, techniques, and technologies may be implemented. In the example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050), while other tasks (e.g., storage of data to be used in subsequent processing) can be performed in the cloud 1010.

In example environment 1000, the cloud 1010 provides services for connected devices 1030, 1040, 1050 with a variety of screen capabilities. Connected device 1030 represents a device with a computer screen 1035 (e.g., a mid-size screen). For example, connected device 1030 could be a personal computer such as desktop computer, laptop, notebook, netbook, or the like. Connected device 1040 represents a device with a mobile device screen 1045 (e.g., a small size screen). For example, connected device 1040 could be a mobile phone, smart phone, personal digital assistant, tablet computer, and the like. Connected device 1050 represents a device with a large screen 1055. For example, connected device 1050 could be a television screen (e.g., a smart television) or another device connected to a television (e.g., a set-top box or gaming console) or the like.

One or more of the connected devices 1030, 1040, and/or 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Services related to API analysis can be provided by the cloud 1010 through the real-time API analysis service (RTAAS) 1020, or through other providers of online services (not depicted). The RTAAS 1020 may have functionalities similar to the RTAAS 106 as described herein. Additionally, the cloud 101 may be used to implement a compatibility analysis engine (CAE) 1021, which may have functions similar to the CAE 110.

In the example environment 1000, the cloud 1010 provides one or more of the technologies and solutions described herein to the various connected devices 1030, 1040, and/or 1050 using, at least in part, the RTAAS 1020.

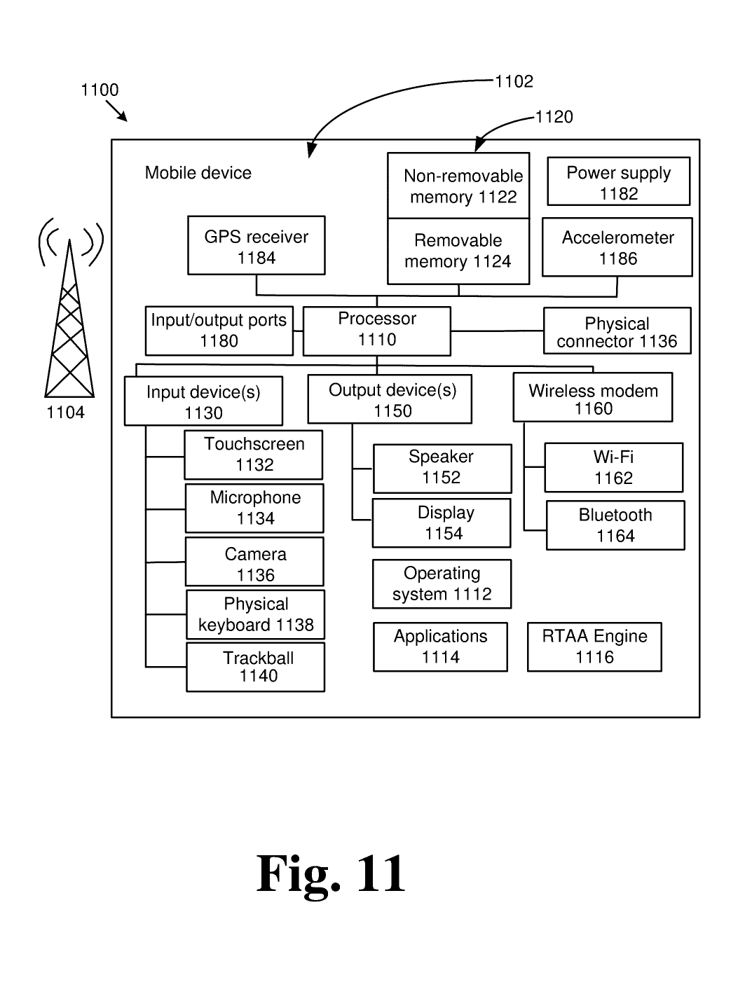

FIG. 11 is an example mobile device that can be used in conjunction with the technologies described herein. Referring to FIG. 11, the example mobile device 1100 may include a variety of optional hardware and software components, shown generally at 1102. Any components 1102 in the mobile device 1100 can communicate with any other component, although not all connections are shown, for ease of illustration. The mobile device 1100 can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140, and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands. Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

In an example embodiment of the disclosure, the mobile device 1100 may further include a real-time API analysis engine (RTAAE) 1116, which may be separate from or implemented as part of the operating system 1112, the applications 1114, and/or the device processor 1110. The RTAAE 1116 may have functionalities similar to the RTAAE 106, as described herein.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 10, computer-readable storage media include memory 1020 and 1025, and storage 1040. By way of example and with reference to FIG. 11, computer-readable storage media may include memory and storage 1120, 1122, and 1124. The term “computer-readable storage media” does not include signals and carrier waves. In addition, the term “computer-readable storage media” does not include communication connections (e.g., 1070, 1160, 1162, and 1164).

In accordance with an example embodiment of the disclosure, a method may include tracking one or more geo-fences using a GNSS (e.g., GPS) hardware processor within a computing device. The tracking may use at least one GNSS (e.g., GPS) signal. State changes of the one or more geo-fences during the tracking may be saved in a shared state database. The shared state database may be shared between the GNSS hardware processor and an application processor within the computing device. Upon detecting a deterioration of the at least one GNSS signal, tracking the one or more geo-fences using the GNSS hardware processor may be switched to tracking the one or more geo-fences using the application processor. After the switching, an initial state of each of the one or more geo-fences may be set using states currently stored in the shared state database prior to the switching.

In accordance with another example embodiment of the disclosure, a computing device may include a GNSS (e.g., GPS) hardware processor configured to track one or more geo-fences using at least one GNSS (e.g., GPS) signal; an application processor configured to take over tracking the one or more geo-fences upon deterioration of the at least one GNSS signal; and a shared state database configured to store state changes of the one or more geo-fences during the tracking. The shared state database may be shared between the GNSS hardware processor and the application processor. Upon switching from tracking the one or more geo-fences using the GNSS hardware processor to tracking the one or more geo-fences using the application processor, the application processor may be operable to set an initial state of each of the one or more geo-fences using states currently stored in the shared state database prior to the switching. Upon detecting an improvement of the at least one GNSS signal, tracking the one or more geo-fences using the application processor may be switched to tracking the one or more geo-fences using the GNSS hardware processor. After the switching back, an initial state of each of the one or more geo-fences may be set using the states currently stored in the shared state database prior to the switching back.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Pert, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing device, comprising:
a processing unit;
memory; and
a display;
the computing device configured to perform operations for real-time analysis of application programming interfaces (APIs), the operations comprising:
receiving a selection of at least one browser version from a plurality of browser versions available in an integrated development environment (IDE);
receiving programming code input;
detecting at least a portion of the programming code input is associated with an application programming interface (API);
determining compatibility of the API with the at least one browser version; and
providing an indication of the determined compatibility of the API.

2. The computing device of claim 1, wherein the operations further comprise:
detecting the at least one browser version from the received programming code input.

3. The computing device of claim 1, wherein the operations further comprise:
retrieving verified programming code for the API; and
comparing the received programming code input with the verified programming code.

4. The computing device of claim 3, wherein the operations further comprise:
detecting at least one coding error based on the comparing.

5. The computing device of claim 4, wherein the operations further comprise:
determining at least one remediation action based on the detected at least one coding error; and
while receiving at least a portion of the programming code input, providing the at least one remediation action for display by the computing device.

6. The computing device of claim 1, wherein the operations further comprise:
communicating the at least one browser version and the at least a portion of the programming code input identifying the API to a remote server computer; and
receiving from the remote server computer API analysis information, wherein the determining of the compatibility is based on the API analysis information.

7. The computing device of claim 6, wherein the API analysis information comprises at least one of the following:
information identifying one or more browsers compatible with the API;
information identifying at least another version of the API, the at least another version compatible with the at least one browser version; or
at least one library for inclusion with the API, wherein the API using the at least one library is compatible with the at least one browser version.

8. A method, implemented at least in part by a computing device, for real-time analysis of application programming interfaces (APIs), the method comprising:
in response to at least receiving programming code input:
detecting the programming code input is associated with at least a portion of an application programming interface (API);
detecting at least one coding error associated with the API based on static analysis of the received programming code input, wherein the static analysis comprises:
receiving an indication of at least one browser version for a browser associated with implementing the programming code; and
comparing the received programming code with programming code for the API verified for the at least one browser version, to detect the at least one coding error;
receiving based at least in part on the at least one browser version, information identifying at least a first remediation action for correcting the at least one coding error; and
providing the at least a first remediation action for display to a user of the computing device.

9. The method according to claim 8, further comprising:
receiving access to a plurality of APIs compatible with the at least one browser version; and
comparing the at least a portion of the API with the plurality of APIs.

10. The method according to claim 9, further comprising:
receiving programming code for at least one new API compatible with the at least one browser version; and
updating the plurality of APIs with the at least one new API.

11. The method according to claim 9, further comprising:
determining incompatibility of the API associated with the programming code input with the at least one browser version for the browser based on the comparison of the at least a portion of the API with the plurality of APIs.

12. The method according to claim 11, wherein determining the incompatibility of the API with the at least one browser version is further based at least in part on the at least one coding error.

13. The method according to claim 11, further comprising:
determining at least a second remediation action for remediating the incompatibility.

14. The method according to claim 13, wherein the second remediation action comprises at least one of the following:
a recommendation not to use the API;
a recommendation to use an alternative API from the plurality of APIs;
a recommendation comprising at least one change to the received programming code input, the at least one change resulting in compatibility of the API with the at least one browser version; and
a recommendation to use at least one library with the API, wherein a combination of the API with the at least one library is compatible with the at least one browser version.

15. The method according to claim 13, further comprising:
providing in real-time, the at least a second remediation action for display to the user of the computing device.

16. A computer-readable storage medium storing computer-executable instructions for causing a computing device to perform a method for analysis of application programming interfaces (APIs), the stored instructions comprising:
instructions to receive a selection of a browser version for a browser used in an integrated development environment (IDE);
instructions to detect at least a portion of programming code input is associated with an application programming interface (API);
instructions to use a static analysis engine at the computing device, performing static analysis of the programming code input to detect at least one coding error associated with the API;
instructions to receive from a compatibility analysis engine, compatibility data indicating whether the programming code input associated with the API is compatible with the browser version; and
while displaying at least a portion of the programming code input:
providing for display, a first indication of the at least one coding error; and
providing for display, a second indication of the compatibility data.

17. The computer-readable storage medium according to claim 16, wherein at least a portion of the compatibility analysis engine is implemented in a second computing device communicatively coupled to the computing device.

18. The computer-readable storage medium according to claim 17, the stored instructions further comprising instructions to communicate all of the following information to the compatibility analysis engine at the second computing device:
the detected at least one coding error;
information identifying the API; and
the browser version.

19. The computer-readable storage medium according to claim 16, wherein the first indication comprises highlighting the at least one coding error, and the stored instructions further comprise:
instructions to provide for display with the first indication, a notification of at least one remediation action for remediating the at least one coding error.

20. The computer-readable storage medium according to claim 17, the stored instructions further comprising:
instructions to access by the static analysis engine at least one remote database to perform the static analysis, the remote database comprising API compatibility data associated with a plurality of programming languages and/or a plurality of web browsers.
